(19) United States
(12) Patent Application Publication
(10) Pub. No.: US 2018/0050692 A1
(43) Pub. Date: Feb. 22, 2018

(54) Automated Co-Pilot Control For Autonomous Vehicles

(71) Applicant: GM GLOBAL TECHNOLOGY OPERATIONS LLC, Detroit, MI (US)

(72) Inventors: Keun Jae Kim, Novi, MI (US); Padma Sundaram, West Bloomfield, MI (US); Rami I. Debouk, Dearborn, MI (US); Dean C. Degazio, Birmingham, MI (US); Brian N. Siskoy, Berkley, MI (US)

(21) Appl. No.: 15/240,092

(22) Filed: Aug. 18, 2016

(51) Int. Cl. B60W 30/09; G05D 1/00; B60W 10/04; B60W 10/10; B60W 10/18; B60W 10/20; B60W 30/12; G05D 1/02; G01C 21/34

(52) U.S. Cl. CPC B60W 30/09; G05D 1/0088; B60W 10/04; B60W 10/10; G01S 19/13; B60W 10/20; B60W 30/12; G05D 1/0212; G01C 21/34; B60W 10/18

(57) ABSTRACT

An automotive vehicle a vehicle steering system, an actuator configured to control the steering system, a first controller, and a second controller. The first controller is in communication with the actuator, and the second controller is in communication with the actuator and with the first controller. The first controller is configured to communicate an actuator control signal based on a primary automated driving system control algorithm. The actuator control signal includes a commanded actuator setting. The second controller is configured to, in response to a first condition being satisfied, control the actuator according to the actuator control signal. The second controller is also configured to, in response to a second condition being satisfied, control the actuator according to a modified actuator control signal. The modified actuator control signal corresponds to an intermediate actuator setting between the commanded actuator setting and a current actuator setting.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes a vehicle steering system, an actuator configured to control the steering system, a first controller, and a second controller. The first controller is in communication with the actuator, and the second controller is in communication with the actuator and with the first controller. The first controller is configured to communicate an actuator control signal based on a primary automated driving system control algorithm. The actuator control signal includes a commanded actuator setting. The second controller is configured to, in response to a first condition being satisfied, control the actuator according to the actuator control signal. The second controller is also configured to, in response to a second condition being satisfied, control the actuator according to a modified actuator control signal. The modified actuator control signal corresponds to an intermediate actuator setting between the commanded actuator setting and a current actuator setting.

In an exemplary embodiment, the second condition corresponds to a predicted vehicle path based on the actuator control signal deviating from a current lane, deviating from a current vehicle route, or passing within a threshold distance of a detected obstacle. In such an embodiment, the first condition corresponds to the predicted path based on the actuator control signal maintaining the current lane, maintaining the current vehicle route, and not passing within the threshold distance of a detected obstacle.

In an exemplary embodiment, the second controller is further configured to, in response to a third condition being satisfied, control the actuator according to a second modified actuator control signal. The second modified actuator control signal corresponds to a second intermediate actuator setting between the intermediate actuator setting and the current actuator setting.

In an exemplary embodiment, the second controller is further configured to, in response to a fourth condition being satisfied, control the actuator according to a third modified actuator control signal. The third modified actuator control signal corresponds to the current actuator setting.

In an exemplary embodiment, the second controller is further configured to, in response to a fifth condition being satisfied, control the actuator according to a fallback command.

In an exemplary embodiment, the first controller is associated with a first CPU and the second controller is associated with a second CPU.

In an exemplary embodiment, the vehicle further includes a second actuator configured to control a vehicle throttle, a third actuator configured to control vehicle brakes, and a fourth actuator configured to control vehicle shifting. In such an embodiment, the controller is additionally in communication with the second actuator, third actuator, and fourth actuator.

A method of controlling a vehicle according to the present disclosure includes providing the vehicle with an actuator configured to control vehicle steering, throttle, braking, or shifting. The method also includes providing the vehicle with a first controller in communication with the actuator. The first controller has a primary automated driving system control algorithm. The method additionally includes providing the vehicle with a second controller. The second controller is in communication with the actuator and the first controller. The method further includes communicating, from the first controller, a commanded actuator setting based on the primary automated driving system control algorithm. The method further includes, in response to a first limit condition being satisfied, controlling, by the second controller, the actuator to a first limit setting. The first limit setting is between the commanded actuator setting and a current actuator setting.

According to an exemplary embodiment, the first limit condition corresponds to a predicted vehicle path based on the actuator control signal deviating from a current lane, deviating from a current vehicle route, or passing within a threshold distance of a detected obstacle.

According to an exemplary embodiment, the method additionally includes, in response to an accept condition being satisfied, controlling, by the second controller, the actuator according to the commanded actuator setting. In such an embodiment, the accept condition may correspond to the predicted path based on the actuator control signal maintaining the current lane, maintaining the current vehicle route, and not passing within the threshold distance of a detected obstacle.

According to an exemplary embodiment, the method additionally includes, in response to a reject condition being satisfied, controlling, by the second controller, the actuator according to a fallback command.

According to an exemplary embodiment, the method additionally includes, in response to a second limit condition being satisfied, controlling, by the second controller, the actuator to a second limit setting, the second limit setting corresponding to the current actuator setting.

An automated driving system for a vehicle includes an actuator configured to control vehicle steering, throttle, braking, or shifting. The automated driving system includes a first controller in communication with the actuator. The first controller is configured to communicate a commanded actuator setting based on a primary automated driving system control algorithm. The automated driving system also includes a second controller in communication with the actuator and with the first controller. The second controller is configured to, in response to a first limit condition being satisfied, control the actuator to a first limit setting. The first limit setting is between the commanded actuator setting and a current actuator setting.

In an exemplary embodiment, the first limit condition corresponds to a predicted vehicle path based on the actuator control signal deviating from a current lane, deviating from a current vehicle route, or passing within a threshold distance of a detected obstacle.

In an exemplary embodiment, the second controller is further configured to, in response to an accept condition being satisfied, control the actuator according to the commanded actuator setting. In such an embodiment, the accept condition may correspond to the predicted path based on the actuator control signal maintaining the current lane, maintaining the current vehicle route, and not passing within the threshold distance of a detected obstacle.

In an exemplary embodiment, the second controller is further configured to, in response to a reject condition being satisfied, control the actuator according to a fallback command.

In an exemplary embodiment, the second controller is further configured to, in response to a second limit condition being satisfied, control the actuator to a second limit setting, the second limit setting corresponding to the current actuator setting.

In an exemplary embodiment, the first controller is associated with a first CPU and the second controller is associated with a second CPU.

Embodiments according to the present disclosure provide a number of advantages. For example, embodiments according to the present disclosure may enable independent validation of autonomous vehicle control commands to aid in diagnosis of software or hardware conditions in the primary control system. Embodiments according to the present disclosure may thus be more robust, increasing customer satisfaction.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of a vehicle according to the present disclosure;

FIG. 2 is a schematic representation of a first embodiment of a system for controlling a vehicle according to the present disclosure;

FIG. 3 is a schematic representation of a second embodiment of a system for controlling a vehicle according to the present disclosure;

FIG. 4 is a flowchart representation of a first embodiment of a method for controlling a vehicle according to the present disclosure;

FIG. 5 is a flowchart representation of a second embodiment of a method for controlling a vehicle according to the present disclosure; and

FIG. 6 is an illustration of modification of an actuator control signal according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

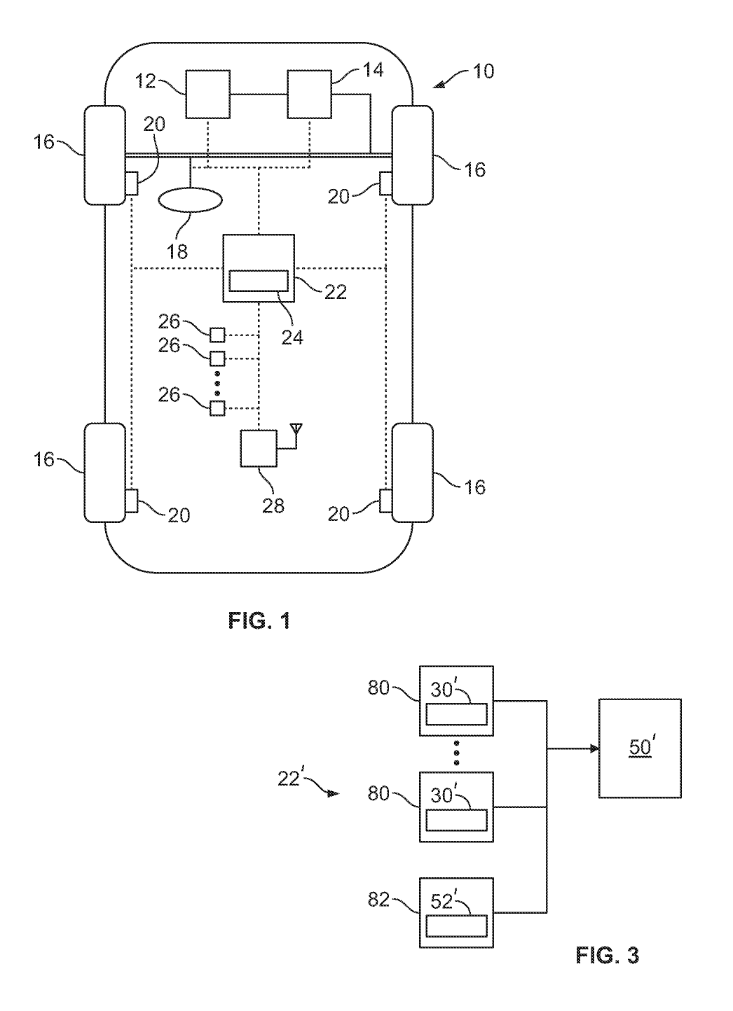

Referring now to FIG. 1, an automotive vehicle 10 according to the present disclosure is shown in schematic form. The automotive vehicle 10 may alternatively be referred to as a host vehicle. The automotive vehicle 10 includes a propulsion system 12, which may in various embodiments include an internal combustion engine, an electric machine such as a traction motor, and/or a fuel cell propulsion system.

The automotive vehicle 10 also includes a transmission 14 configured to transmit power from the propulsion system 12 to vehicle wheels 16 according to selectable speed ratios. According to various embodiments, the transmission 14 may include a step-ratio automatic transmission, a continuously-variable transmission, or other appropriate transmission.

The automotive vehicle 10 additionally includes a steering system 18. While depicted as including a steering wheel for illustrative purposes, in some embodiments contemplated within the scope of the present disclosure, the steering system 18 may not include a steering wheel.

The automotive vehicle 10 additionally includes a plurality of vehicle wheels 16 and associated wheel brakes 20 configured to provide braking torque to the vehicle wheels 16. The wheel brakes 20 may, in various embodiments, include friction brakes, a regenerative braking system such as an electric machine, and/or other appropriate braking systems.

The propulsion system 12, transmission 14, steering system 18, and wheel brakes 20 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 is provided with an automated driving system (ADS) 24 for automatically controlling various actuators in the vehicle 10. In an exemplary embodiment, the ADS 24 is configured to control the propulsion system 12, transmission 14, steering system 18, and wheel brakes 20 to control vehicle acceleration, steering, and braking, respectively, without human intervention.

The ADS 24 is configured to control the propulsion system 12, transmission 14, steering system 18, and wheel brakes 20 in response to inputs from a plurality of sensors 26, which may include GPS, RADAR, LIDAR, optical cameras, thermal cameras, ultrasonic sensors, and/or additional sensors as appropriate.

The vehicle 10 additionally includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

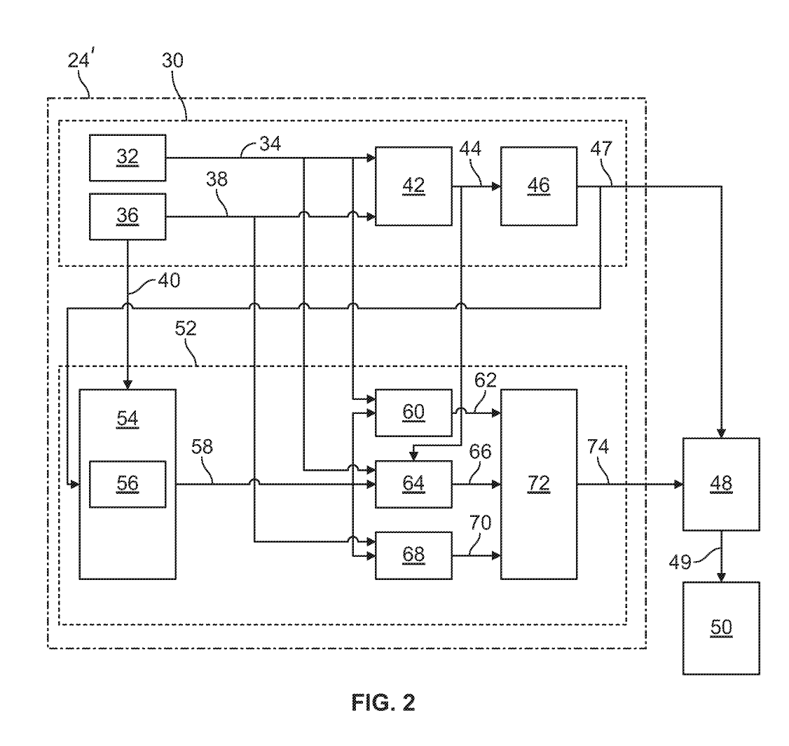

Referring now to FIG. 2, an exemplary architecture for an ADS 24′ according to the present disclosure is illustrated. The ADS 24′ may be provided via one or more controllers in a host vehicle as illustrated in FIG. 1 and discussed in further detail below.

The ADS 24′ includes multiple distinct control systems, as will be discussed in further detail below. Among the multiple distinct control systems is at least one primary control system 30.

The primary control system 30 includes a sensor fusion module 32 for determining the presence, location, and path of detected features in the vicinity of the host vehicle. The sensor fusion module 32 is configured to receive inputs from a variety of sensors, such as the sensors 26 illustrated in FIG. 1. The sensor fusion module 32 processes and synthesizes the inputs from the variety of sensors and generates a sensor fusion output 34. The sensor fusion output 34 includes various calculated parameters including, but not limited to, a location of a detected obstacle relative to the host vehicle, a predicted path of the detected obstacle relative to the host vehicle, and a location and orientation of traffic lanes relative to the host vehicle.

The primary control system 30 also includes a mapping and localization module 36 for determining the location of the host vehicle and route for a current drive cycle. The mapping and localization module 36 is also configured to receive inputs from a variety of sensors, such as the sensors 26 illustrated in FIG. 1. The mapping and localization module 36 processes and synthesizes the inputs from the variety of sensors, and generates a mapping and localization output 38. The mapping and localization output 38 includes various calculated parameters including, but not limited to, a host vehicle route for the current drive cycle, and a current host vehicle location relative to the route. In addition, the mapping and localization module 36 generates a vehicle location output 40. The vehicle location output 40 includes the current host vehicle location relative to the route, and is used in a separate calculation as will be discussed below.

The primary control system 30 additionally includes a path planning module 42 for determining a host vehicle path to be followed to maintain the host vehicle on the desired route while obeying traffic laws and avoiding any detected obstacles. The path planning module 42 employs a first obstacle avoidance algorithm configured to avoid any detected obstacles in the vicinity of the host vehicle, a first lane keeping algorithm configured to maintain the host vehicle in a current traffic lane, and a first route keeping algorithm configured to maintain the host vehicle on the desired route. The path planning module 42 is configured to receive the sensor fusion output 34 and the mapping and localization output 38. The path planning module 42 processes and synthesizes the sensor fusion output 34 and the mapping and localization output 38, and generates a path planning output 44. The path planning output 44 includes a commanded host vehicle path based on the vehicle route, host vehicle location relative to the route, location and orientation of traffic lanes, and the presence and path of any detected obstacles.

The primary control system 30 further includes a vehicle control module 46 for issuing control commands to vehicle actuators. The vehicle control module employs a first path algorithm for calculating a host vehicle path resulting from a given set of actuator settings. The vehicle control module 46 is configured to receive the path planning output 44. The vehicle control module 46 processes the path planning output 44 and generates a vehicle control output 47. The vehicle control output 47 includes a set of actuator commands to achieve the commanded path from the vehicle control module 46, including but not limited to a steering command, a shift command, a throttle command, and a brake command.

The vehicle control output 47 is communicated to a secondary arbitration module 48, which will be discussed in further detail below. The secondary arbitration module 48 outputs an actuator control output 49 to actuators 50. In an exemplary embodiment, the actuators 50 include a steering control, a shifter control, a throttle control, and a brake control. The steering control may, for example, control a steering system 18 as illustrated in FIG. 1. The shifter control may, for example, control a transmission 14 as illustrated in FIG. 1. The throttle control may, for example, control a propulsion system 12 as illustrated in FIG. 1. The brake control may, for example, control wheel brakes 20 as illustrated in FIG. 1.

In addition to the primary control system 30, the ADS 24′ also includes at least one orthogonal co-pilot system 52. The orthogonal co-pilot system 52 is configured to verify and, if necessary, override the operation of the primary control system 30 using distinct algorithms from those employed in the primary control system 30.

The orthogonal co-pilot system 52 includes a path calculation module 54. The path calculation module 54 is configured to receive the vehicle location output 40 and the vehicle control output 47. The path calculation module 54 processes and synthesizes the vehicle location output 40 and the vehicle control output 47, and generates a path calculation output 58. The path calculation output 58 includes a first predicted path and a second predicted path. The first predicted path is based on the path planning output 44 and corresponds to a predicted path the host vehicle would follow if the actuators 50 are controlled according to the vehicle control output 47. The second predicted path is based on current actuator settings and corresponds to a predicted path the host vehicle would follow if the vehicle control output 47 is disregarded and the actuators 50 are maintained at respective current settings for each actuator 50. The path calculation module 54 includes a vehicle model 56 and employs a second path algorithm, which are distinct from the first path algorithm used in the vehicle control module 46.

The orthogonal co-pilot system 52 also includes an obstacle avoidance verification module 60. The obstacle avoidance verification module 60 is provided to verify that the host vehicle maintains a desired distance from any detected obstacles, such as other vehicles and/or roadside objects. The obstacle avoidance verification module 60 is configured to receive the path calculation output 58 and the sensor fusion output 34. The obstacle avoidance verification module 60 processes and synthesizes the path calculation output 58 and the sensor fusion output 34 and generates an obstacle avoidance verification output 62. The obstacle avoidance verification output 62 may include a signal indicating the presence or absence of an obstacle in the first predicted path and/or in the second predicted path. In an exemplary embodiment, the obstacle avoidance verification output 62 includes an ACCEPT flag in response to the first predicted path not passing within a threshold distance of any detected obstacle, a LIMIT flag in response to the first predicted path passing within the threshold distance of a detected obstacle while the second predicted path does not pass within the threshold distance of the detected obstacle, and a REJECT flag in response to both the first predicted path and the second predicted path passing within the threshold distance of the detected obstacle. In addition, the obstacle avoidance verification output 62 may include a predicted time until contacting any detected obstacles. The obstacle avoidance verification module 60 employs a second obstacle avoidance algorithm, which is distinct from the first obstacle avoidance algorithm used in the path planning module 42.

The orthogonal co-pilot system 52 additionally includes a lane keeping verification module 64. The lane keeping verification module 64 is provided to maintain the host vehicle in a desired traffic lane. The lane keeping verification module 64 is configured to receive the path calculation output 58 and the sensor fusion output 34. The lane keeping verification module 64 processes and synthesizes the path calculation output 58 and the sensor fusion output 34 and generates a lane keeping verification output 66. The lane keeping verification output 66 may include a signal indicating whether the first predicted path and/or the second predicted path would maintain the host vehicle in a current traffic lane. In an exemplary embodiment, the lane keeping verification output 66 includes an ACCEPT flag in response to the first predicted path maintaining the host vehicle in the current traffic lane, a LIMIT flag in response to the first predicted path deviating from the current traffic lane while the second predicted path maintains the host vehicle in the current traffic lane, and a REJECT flag in response to both the first predicted path and the second predicted path deviating from the current traffic lane. In addition, the lane keeping verification output 66 may include a predicted time until the host vehicle departs the current traffic lane. The lane keeping verification module 64 employs a second lane keeping algorithm, which is distinct from the first lane keeping algorithm used in the path planning module 42.

The orthogonal co-pilot system 52 further includes a route keeping verification module 68. The route keeping verification module 68 is provided to maintain the host vehicle on a desired route and within an authorized operating environment. The route keeping verification module 68 is configured to receive the path calculation output 58 and the mapping and localization output 38. The route keeping verification module 68 processes and synthesizes the path calculation output 58 and the mapping and localization output 38 and generates a route keeping verification output 70. The route keeping verification output 70 may include a signal indicating whether the first predicted path and/or the second predicted path would maintain the host vehicle on the route for the current drive cycle. In an exemplary embodiment, the route keeping verification output 70 includes an ACCEPT flag in response to the first predicted path maintaining the host vehicle on the route, a LIMIT flag in response to the first predicted path deviating from the route while the second predicted path maintains the host vehicle on the route, and a REJECT flag in response to both the first predicted path and the second predicted path deviating from the route. In addition, the route keeping verification output 70 may include a predicted time until the host vehicle departs the route. The route keeping verification module 68 employs a second route keeping algorithm, which is distinct from the first route keeping algorithm used in the path planning module 42.

The orthogonal co-pilot system 52 further includes an initial arbitration module 72. The initial arbitration module 72 is configured to receive the obstacle avoidance verification output 62, the lane keeping verification output 66, and the route keeping verification output 70. The arbitration module processes and synthesizes the obstacle avoidance verification output 62, the lane keeping verification output 66, and the route keeping verification output 70, and outputs an orthogonal control output 74. The orthogonal control output 74 may include a signal to accept the vehicle control output 47, a signal to limit the vehicle control output 47, or a signal to reject the vehicle control output 47.

The secondary arbitration module 48 is configured to receive the vehicle control output 47 and the orthogonal control output 74. The secondary arbitration module processes and synthesizes the vehicle control output 47 and the orthogonal control output 74 and outputs an actuator control output 49 to the actuators 50. The orthogonal control output 74 includes commanded settings for the actuators 50, such as a desired steering gradient for a steering actuator or a desired throttle gradient for a throttle actuator.

By providing the orthogonal co-pilot system 52 with algorithms distinct from those employed in the primary control system 30, the commanded path and actuator control signals may be validated independently from any software diagnostic conditions arising in the primary control system 30.

Referring now to FIG. 3, an exemplary architecture for a controller 22′ according to the present disclosure is illustrated schematically. The controller 22′ includes at least one primary microprocessor 80 and associated non-transient data storage provided with a primary control system 30′, which may be configured generally similarly to the primary control system 30 illustrated in FIG. 2. In the exemplary embodiment of FIG. 3, multiple primary microprocessors 80 are provided, each with associated non-transient data storage having a primary control system 30′. In addition, at least one orthogonal microprocessor 82 is provided, distinct from the one or more primary microprocessors 80. The orthogonal microprocessor 82 is provided with associated non-transient data storage having an orthogonal co-pilot system 52′, which may be configured generally similarly to the orthogonal co-pilot system 52 illustrated in FIG. 2. Vehicle actuators 50′ are under the collective control of the one or more primary microprocessors 80 and the at least one orthogonal microprocessor 82. While only one orthogonal microprocessor 82 is provided in the illustrative embodiment of FIG. 3, in other considered embodiments, multiple orthogonal microprocessors are provided.

By providing the orthogonal co-pilot system 52′ on a distinct hardware from that of the primary control system 30′, the commanded path and actuator control signals may be validated independently from any hardware diagnostic conditions arising in the one or more primary microprocessors 80.

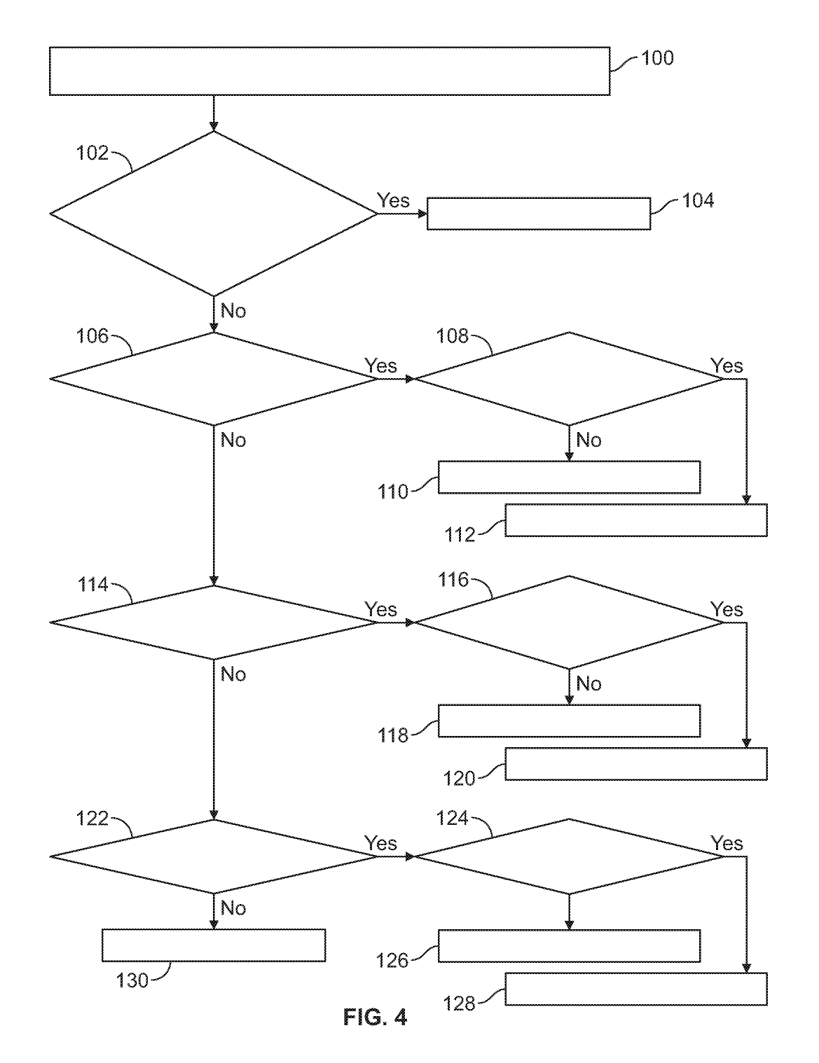

Referring now to FIG. 4, an exemplary embodiment of an initial arbitration algorithm, e.g. as may be used in the initial arbitration module 72, is illustrated in flowchart form.

The algorithm begins with receiving obstacle avoidance verification output, lane keeping verification output, and route keeping verification output, as illustrated at block 100.

A determination is made of whether among the obstacle avoidance verification output 62, lane keeping verification output 66, route keeping verification output 70, or combination thereof, a flag is set to REJECT, as illustrated at operation 102. In the embodiment illustrated in FIG. 4, the evaluated flags include an obstacle_avoid_verify flag, a lane_verify flag, and a route_verify flag. A flag being set to REJECT indicates that at least one module has determined that the vehicle control output 47 would result in undesirable or otherwise sub-optimal behavior.

In response to the determination of operation 102 being positive, i.e. at least one flag is set to REJECT, an arbitration output signal requestSM is set to REJECT, as illustrated at block 104. In response to the arbitration output signal requestSM being set to REJECT, the secondary arbitration module 48 may automatically reject the vehicle control output 47 and instead control the actuators 50 to perform an alternative maneuver, which may be referred to as a secondary command. The secondary command may include, for example, a fallback command to safely stop and remove the host vehicle from traffic. Such maneuvers may be referred to as minimal risk condition maneuvers.

In response to the determination of operation 102 being negative, i.e. no flags are set to REJECT, then a determination is made of whether the obstacle_avoid_verify flag is set to LIMIT. The obstacle_avoid_verify flag being set to LIMIT indicates that the orthogonal co-pilot system 52, e.g. the obstacle avoidance verification module 60, has determined that a predicted path based on current actuator settings would not result in the host vehicle passing within a threshold distance of any detected obstacles.

If the determination of operation 106 is positive, then a determination is made of whether a time_to_obstacle value is less than a calibratable threshold, as illustrated at operation 108. The time_to_obstacle value corresponds to a predicted time until the host vehicle would pass within the threshold distance of a detected obstacle, if controlled according to the vehicle control output 47 of the primary control system 30.

In response to the determination of operation 108 being negative, i.e. the time_to_obstacle value being greater than or equal to the threshold, then the arbitration output signal requestSM is set to LIMIT_LEVEL1, as illustrated at block 110.

In response to the determination of operation 108 being positive, i.e. the time_to_obstacle value being less than the threshold, then the arbitration output signal requestSM is set to LIMIT_LEVEL2, as illustrated at block 112.

In response to the arbitration output signal requestSM being set to LIMIT_LEVEL1 or LIMIT_LEVEL2, the secondary arbitration module 48 may control the actuators 50 according to a modified control output relative to the vehicle control output 47 of the primary control system 30. In an exemplary embodiment, LIMIT_LEVEL2 corresponds to a more significant deviation from the vehicle control output 47 relative to LIMIT_LEVEL1. In an exemplary embodiment, in response to requestSM being set to LIMIT_LEVEL2, the actuators 50 are maintained at respective current actuator settings, e.g. by disregarding the vehicle control output 47, while in response to requestSM being set to LIMIT_LEVEL1, the actuators are controlled to respective settings between the respective current actuator settings and respective settings according to the vehicle control output 47.

Returning to operation 106, if the obstacle_avoid_verify flat is not set to LIMIT, then a determination is made of whether a lane_verify flag is set to LIMIT, as illustrated at operation 114. The lane_verify flag being set to LIMIT indicates that the orthogonal co-pilot system 52, e.g. the lane keeping verification module 64, has determined that a predicted path based on current actuator settings would not result in the host vehicle deviating from the current lane by a threshold amount.

If the determination of operation 114 is positive, then a determination is made of whether a TimeToLaneDev value is less than a calibratable threshold, as illustrated at operation 116. The TimeToLaneDev value corresponds to a predicted time remaining until the host vehicle would deviate from the current lane, if controlled according to the vehicle control output 47 of the primary control system 30.

In response to the determination of operation 116 being negative, i.e. the TimeToLaneDev value being greater than or equal to the threshold, then the arbitration output signal requestSM is set to LIMIT_LEVEL1, as illustrated at block 118.

In response to the determination of operation 116 being positive, i.e. the TimeToLaneDev value being less than the threshold, then the arbitration output signal requestSM is set to LIMIT_LEVEL2, as illustrated at block 120.

Returning to operation 114, if the lane_verify flat is not set to LIMIT, then a determination is made of whether a route_verify flag is set to LIMIT, as illustrated at operation 122. The route_verify flag being set to LIMIT that the orthogonal co-pilot system 52, e.g. the route keeping verification module 68, has determined that a predicted path based on current actuator settings would not result in the host vehicle deviating from the current route by a threshold amount.

If the determination of operation 122 is positive, then a determination is made of whether a TimeToRouteDev value is less than a calibratable threshold, as illustrated at operation 116. The TimeToRouteDev value corresponds to a predicted time remaining until the host vehicle would deviate from the current route, if controlled according to the vehicle control output 47 of the primary control system 30.

In response to the determination of operation 124 being negative, i.e. the TimeToRouteDev value being greater than or equal to the threshold, then the arbitration output signal requestSM is set to LIMIT_LEVEL1, as illustrated at block 126.

In response to the determination of operation 124 being positive, i.e. the TimeToRouteDev value being less than the threshold, then the arbitration output signal requestSM is set to LIMIT_LEVEL2, as illustrated at block 128.

Returning to operation 122, if the route_verify flag is not set to LIMIT, then the arbitration output signal requestSM is set to ACCEPT, as illustrated at block 130. In response to the arbitration output signal requestSM being set to ACCEPT, the secondary arbitration module 48 may control the actuators 50 according to the vehicle control output 47.

In an exemplary embodiment, a host vehicle includes distinct copilot systems, each configured generally similar to the copilot system 52, associated with each primary control system. In such embodiments, the secondary arbitration module 58 may perform an additional arbitration process to arbitrate among the outputs of the multiple copilot systems.

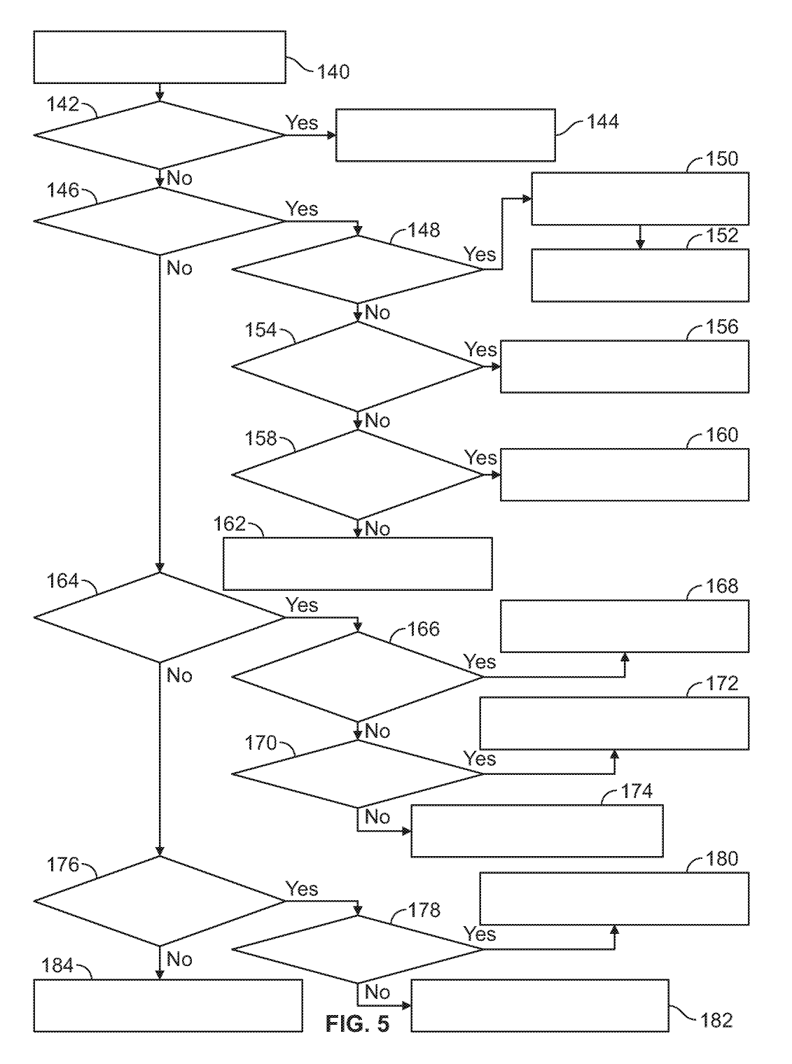

Referring now to FIG. 5, an additional exemplary embodiment of a secondary arbitration algorithm, e.g. as may be implemented in the secondary arbitration module 48, is illustrated in flowchart form. In this illustrative embodiment, first and second copilot systems similar to the copilot system 52 are implemented, each having an initial arbitration module configured to generate an orthogonal control output signal. The first copilot system is associated with a first primary control system and the second copilot system is associated with a second primary control system.

A first orthogonal control output signal RequestSM1 and a second orthogonal control output signal RequestSM2 are received from a first copilot system and a second copilot system respectively, as illustrated at block 140. In an exemplary embodiment, the first orthogonal control output signal RequestSM1 and the second orthogonal control output signal RequestSM2 are determined by the first and second copilot systems, respectively, generally in the same manner as discussed above with respect to RequestSM in FIG. 4. In addition, a driver input signal Driver_Input is received, as also illustrated at block 140. In an exemplary embodiment, the driver input signal is assigned a value of TRUE in response to an operator input to a steering, acceleration, braking, or shifting input device, and assigned a value of FALSE in response to no such operator input being applied. As an example, the driver input signal may be assigned a value of TRUE in response to an operator turning a steering wheel.

A determination is made of whether the value of Driver_Input is TRUE, as illustrated at operation 142.

In response to the determination of operation 142 being positive, a final arbitration output requestSM_arbitration is set to REJECT, as illustrated at block 144. In response to the final arbitration output requestSM_arbitration being set to REJECT, the secondary arbitration module may automatically reject the vehicle control output 47. The host vehicle may thus be controlled according to driver inputs.

In response to the determination of operation 142 being negative, i.e. Driver_Input being FALSE, a determination is made of whether the first orthogonal control output signal RequestSM1 is equal to REJECT, as illustrated at operation 146. The first orthogonal control output signal RequestSM1 being set to REJECT indicates that the first copilot system has determined that the vehicle control output of the first primary control system should be disregarded, and that current actuator settings may result in undesirable host vehicle behavior.

In response to the determination of operation 146 being positive, a determination is made of whether the second orthogonal control output signal RequestSM2 is equal to REJECT, as illustrated at operation 148. The second orthogonal control output signal RequestSM2 being set to REJECT indicates that the second copilot system has determined that the vehicle control output of the second primary control system should be disregarded, and that current actuator settings may result in undesirable host vehicle behavior.

In response to the determination of operation 148 being positive, i.e. both the first orthogonal control output signal RequestSM1 and the second orthogonal control output signal RequestSM2 being set to REJECT, then a secondary command is generated, as illustrated at block 150. In an exemplary embodiment, the secondary command is generated by a secondary arbitration module as illustrated in FIG. 2. As discussed above, the secondary command may include a fallback command to safely stop the host vehicle. The final arbitration output requestSM_arbitration is then set to SECONDARY_CMD, as illustrated in block 152. In an exemplary embodiment, in response to the final arbitration output requestSM_arbitration being set to SECONDARY_CMD, the secondary arbitration module 48 controls the actuators 50 according to the secondary command. Thus, if both the first copilot system and second copilot system determine that the respective vehicle control outputs of both the first primary control system and the second primary control system should be disregarded, then the secondary arbitration module may control the actuators 50 to automatically execute a maneuver to safely stop the host vehicle.

Returning to operation 148, if the determination is negative, i.e. the first orthogonal control output signal RequestSM1 is set to REJECT and the second orthogonal control output signal RequestSM2 is not set to REJECT, then a determination is made of whether the second orthogonal control output signal RequestSM2 is set to LIMIT_LEVEL1, as illustrated at operation 154.

If the determination of operation 154 is positive, then the final arbitration output requestSM_arbitration is set to PRIMARY_CMD2_LIMIT1, as illustrated at block 156. In response to the final arbitration output requestSM_arbitration being set to PRIMARY_CMD2_LIMIT1, the actuators 50 are controlled according to a first limit setting, which may be a modified setting relative to the vehicle command output of the second primary control system. In an exemplary embodiment, PRIMARY_CMD2_LIMIT1 corresponds to an actuator setting between a current actuator setting and a commanded actuator setting according to the vehicle command output of the second primary control system.

Returning to operation 154, in response to the determination being negative, a determination is made of whether the second orthogonal control output signal RequestSM2 is set to LIMIT_LEVEL2, as illustrated at operation 158.

In response to the determination of operation 158 being positive, the final arbitration output requestSM_arbitration is set to PRIMARY_CMD2_LIMIT2, as illustrated at block 160. In response to the final arbitration output requestSM_arbitration being set to PRIMARY_CMD2_LIMIT2 the secondary arbitration module may control the actuators 50 according to a second limit setting, which may be a modified setting relative to the vehicle command output of the second primary control system. In an exemplary embodiment, PRIMARY_CMD2_LIMIT2 corresponds to the current actuator setting, e.g. disregarding the vehicle command output of the second primary control system.

In response to the determination of operation 158 being negative, then the final arbitration output requestSM_arbitration is set to PRIMARY_CMD2_NOLIMIT, as illustrated at block 162. In an exemplary embodiment, in response to the final arbitration output requestSM_arbitration being set to PRIMARY_CMD2_NOLIMIT, the secondary arbitration module may control the actuators 50 according to the vehicle command output of the second primary control system.

Returning to operation 146, in response to the determination being negative, a determination is made of whether the first orthogonal control output signal RequestSM1 is set to LIMIT_LEVEL1, as illustrated at operation 164.

In response to the determination of operation 164 being positive, a determination is made of whether the second orthogonal control output signal RequestSM2 is set to LIMIT_LEVEL2, as illustrated at operation 166.

In response to the determination of operation 166 being positive, the final arbitration output requestSM_arbitration is set to PRIMARY_CMD2_LIMIT2. As discussed above, in response to the final arbitration output requestSM_arbitration being set to PRIMARY_CMD2_LIMIT2 the secondary arbitration module may control the actuators 50 according to a second limit setting.

In response to the determination of operation 166 being positive, a determination is made of whether the second orthogonal control output signal RequestSM2 is set to ACCEPT, as illustrated at operation 170.

In response to the determination of operation 170 being positive, the final arbitration output requestSM_arbitration is set to PRIMARY_CMD2_NOLIMIT, as illustrated at block 172. As discussed above, in response to the final arbitration output requestSM_arbitration being set to PRIMARY_CMD2_NOLIMIT, the secondary arbitration module may control the actuators 50 according to the vehicle command output of the second primary control system.

In response to the determination of operation 170 being negative, the final arbitration output requestSM_arbitration is set to PRIMARY_CMD1_LIMIT1, as illustrated at block 174. In response to the final arbitration output requestSM_arbitration being set to PRIMARY_CMD1_LIMIT1, the secondary arbitration module may control the actuators 50 according to a first limit setting, which may be a modified setting relative to the vehicle command output of the first primary control system. In an exemplary embodiment, PRIMARY_CMD1_LIMIT1 corresponds to an actuator setting between a current actuator setting and a commanded actuator setting according to the vehicle command output of the first primary control system.

Returning to operation 164, in response to the determination of operation 164 being negative, a determination is made of whether the first orthogonal control output signal RequestSM1 is set to LIMIT_LEVEL2, as illustrated at operation 176.

In response to the determination of operation 176 being positive, a determination is made of whether the second orthogonal control output signal RequestSM2 is set to ACCEPT, as illustrated at operation 178.

In response to the determination of operation 178 being positive, the final arbitration output requestSM_arbitration is set to PRIMARY_CMD2_NOLIMIT, as illustrated at block 180. As discussed above, in response to the final arbitration output requestSM_arbitration being set to PRIMARY_CMD2_NOLIMIT, the secondary arbitration module may control the actuators 50 according to the vehicle command output of the second primary control system.

In response to the determination of operation 178 being negative, the final arbitration output requestSM_arbitration is set to PRIMARY_CMD1_LIMIT2, as illustrated at block 182. In response to the final arbitration output requestSM_arbitration being set to PRIMARY_CMD1_LIMIT2 the secondary arbitration module may control the actuators 50 according to a second limit setting, which may be a modified setting relative to the vehicle command output of the first primary control system. In an exemplary embodiment, PRIMARY_CMD1_LIMIT2 corresponds to the current actuator setting, e.g. disregarding the vehicle command output of the first primary control system.

Returning to operation 176, in response to the determination of operation 176 being negative, the final arbitration output requestSM_arbitration is set to PRIMARY_CMD1_NOLIMIT, as illustrated at block 184. In an exemplary embodiment, in response to the final arbitration output requestSM_arbitration being set to PRIMARY_CMD2_NOLIMIT, the secondary arbitration module may control the actuators 50 according to the vehicle command output of the first primary control system.

While the embodiment of FIG. 5 illustrates an algorithm for arbitrating between control outputs of two copilot systems, one of ordinary skill in the art will appreciate that a similar strategy may be implemented to arbitrate among control outputs of a greater number of copilot systems.

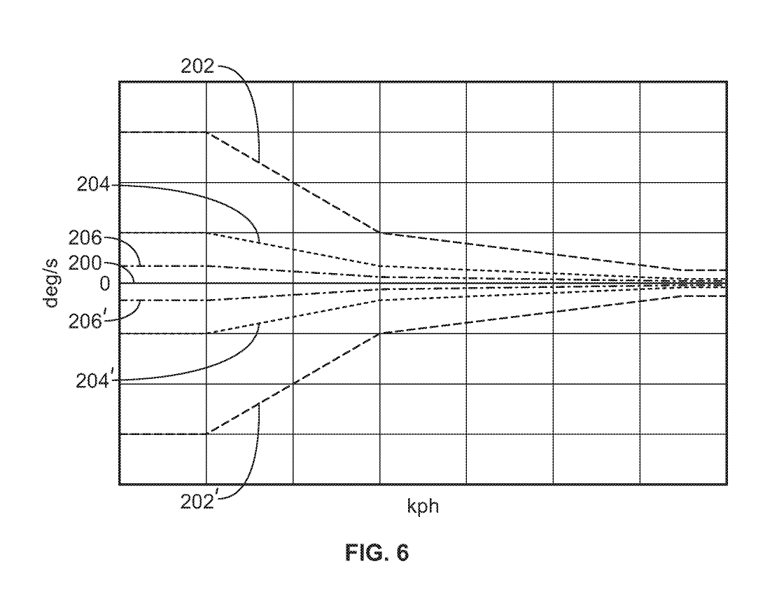

Referring now to FIG. 6, an exemplary method of limiting of an actuator control signal according to the present disclosure is illustrated. In this illustrative embodiment, the actuator includes a steering actuator configured to control vehicle steering. The horizontal axis indicates current host vehicle speed in kilometers per second. The vertical axis indicates steering gradient in degrees per second relative to a current actuator setting 200.

The vehicle command output 47 from the primary control system 30 has a non-limited upper bound 202 and a non-limited lower bound 202′. Here, non-limited refers to the absence of any limit imposed by the orthogonal control system 52. The upper bound 202 and lower bound 202′ have relatively high magnitudes at low vehicle speeds, and relatively low magnitudes at high vehicle speeds. Thus, as host vehicle speed increases, the maximum steering gradient magnitude is decreased.

A first limited upper bound 204 and limited lower bound 204′ are provided, having lesser magnitudes than the unlimited upper bound 202 and an unlimited lower bound 202′. In this embodiment, the first limited upper bound 204 and limited lower bound 204′ are scalar multiples of the non-limited upper bound 202 and a non-limited lower bound 202′. However, in other embodiments the relationship between non-limited and limited bounds may vary with host vehicle speed.

A second limited upper bound 206 and limited lower bound 206′ are likewise provided, having lesser magnitudes than the first limited upper bound 204 and limited lower bound 204′.

In response to a final arbitration output being set to limit level 1, as illustrated in the exemplary embodiment of FIG. 5 and discussed above, the vehicle command output may be limited to the first limited upper bound 204 as a maximum and to the first limited lower bound 204′ as a minimum. In response to a final arbitration output being set to limit level 2, the vehicle command output may be limited to the second limited upper bound 206 as a maximum and to the second limited lower bound 206′ as a minimum. Thus, as the arbitration output imposes tighter limits, the actuator control is maintained more closely to the current actuator setting.

In an exemplary embodiment, at least one limit level corresponds to disregarding the vehicle command output and maintaining the current actuator setting.

As may be seen, embodiments according to the present disclosure may enable independent validation of autonomous vehicle control commands to aid in diagnosis of software or hardware conditions in the primary control system. Embodiments according to the present disclosure may thus be more robust, increasing customer satisfaction.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a vehicle steering system;
an actuator configured to control the steering system;
a first controller programmed with a primary automated driving system control algorithm and configured to communicate an actuator control signal based on the primary automated driving system control algorithm, the actuator control signal including a commanded actuator setting; and
a second controller in communication with the actuator and with the first controller, the second controller being configured to, in response to a first condition being satisfied, automatically control the actuator according to the actuator control signal and, in response to a second condition being satisfied, automatically control the actuator according to a modified actuator control signal, the modified actuator control signal corresponding to an intermediate actuator setting between the commanded actuator setting and a current actuator setting.

2. The automotive vehicle of claim 1, wherein the second condition corresponds to a predicted vehicle path based on the actuator control signal deviating from a current lane, deviating from a current vehicle route, or passing within a threshold distance of a detected obstacle, and wherein the first condition corresponds to the predicted path based on the actuator control signal maintaining the current lane, maintaining the current vehicle route, and not passing within the threshold distance of a detected obstacle.

3. The automotive vehicle of claim 1, wherein the second controller is further configured to, in response to a third condition being satisfied, automatically control the actuator according to a second modified actuator control signal, the second modified actuator control signal corresponding to a second intermediate actuator setting between the intermediate actuator setting and the current actuator setting.

4. The automotive vehicle of claim 1, wherein the second controller is further configured to, in response to a fourth condition being satisfied, automatically control the actuator according to a third modified actuator control signal, the third modified actuator control signal corresponding to the current actuator setting.

5. The automotive vehicle of claim 1, wherein the second controller is further configured to, in response to a fifth condition being satisfied, automatically control the actuator according to a fallback command.

6. The automotive vehicle of claim 1, wherein the first controller is associated with a first processor and the second controller is associated with a second processor.

7. The automotive vehicle of claim 1, wherein the vehicle further includes a second actuator configured to control a vehicle throttle, a third actuator configured to control vehicle brakes, and a fourth actuator configured to control vehicle shifting, and wherein the second controller is additionally in communication with the second actuator, third actuator, and fourth actuator.

8. A method of controlling a vehicle, comprising:
providing the vehicle with an actuator configured to control vehicle steering, throttle, braking, or shifting;
providing the vehicle with a first controller in communication with the actuator and having a primary automated driving system control algorithm;
providing the vehicle with a second controller in communication with the actuator and the first controller;
communicating, from the first controller, a commanded actuator setting based on the primary automated driving system control algorithm; and
in response to a first limit condition being satisfied, automatically controlling, by the second controller, the actuator to a first limit setting, the first limit setting being between the commanded actuator setting and a current actuator setting.

9. The method of claim 8, wherein the first limit condition corresponds to a predicted vehicle path based on the actuator control signal deviating from a current lane, deviating from a current vehicle route, or passing within a threshold distance of a detected obstacle.

10. The method of claim 9, further comprising, in response to an accept condition being satisfied, automatically controlling, by the second controller, the actuator according to the commanded actuator setting.

11. The method of claim 10, wherein the accept condition corresponds to the predicted path based on the actuator control signal maintaining a current lane, maintaining a current vehicle route, and not passing within a threshold distance of a detected obstacle.

12. The method of claim 8, further comprising, in response to a reject condition being satisfied, automatically controlling, by the second controller, the actuator according to a fallback command.

13. The method of claim 8, further comprising, in response to a second limit condition being satisfied, automatically controlling, by the second controller, the actuator to a second limit setting, the second limit setting corresponding to the current actuator setting.

14. A system for autonomous control of a vehicle, comprising:
an actuator configured to control vehicle steering, throttle, braking, or shifting;
a first controller in communication with the actuator, the first controller being programmed with a primary automated driving system control algorithm and configured to communicate a commanded actuator setting based on the primary automated driving system control algorithm; and
a second controller in communication with the actuator and with the first controller, the second controller being configured to, in response to a first limit condition being satisfied, automatically control the actuator to a first limit setting, the first limit setting being between the commanded actuator setting and a current actuator setting.

15. The system of claim 14, wherein the first limit condition corresponds to a predicted vehicle path based on the actuator control signal deviating from a current lane, deviating from a current vehicle route, or passing within a threshold distance of a detected obstacle.

16. The system of claim 15, wherein the second controller is further configured to in response to an accept condition being satisfied, automatically control the actuator according to the commanded actuator setting.

17. The system of claim 16, wherein the accept condition corresponds to the predicted path based on the actuator control signal maintaining the current lane, maintaining the current vehicle route, and not passing within the threshold distance of a detected obstacle.

18. The system of claim 14, wherein the second controller is further configured to, in response to a reject condition being satisfied, automatically control the actuator according to a fallback command.

19. The system of claim 14, wherein the second controller is further configured to, in response to a second limit condition being satisfied, automatically control the actuator to a second limit setting, the second limit setting corresponding to the current actuator setting.

20. The system of claim 14, wherein the first controller is associated with a first processor and the second controller is associated with a second processor.
